(19) United States
(12) Patent Application Publication
(10) Pub. No.: US 2015/0028784 A1
(43) Pub. Date: Jan. 29, 2015

(54) PARALLEL STRUCTURE POWER APPARATUS AND CONTROL METHOD THEREOF

(71) Applicant: SAMSUNG ELECTRO-MECHANICS CO., LTD., Suwon-Si (KR)

(72) Inventors: HAN TAE KIM, Suwon-Si (KR); Kyeoung Hun Park, Suwon-si (KR); Geun Hong Lee, Suwon-si (KR)

(73) Assignee: SAMSUNG ELECTRO-MECHANICS CO., LTD., Suwon-si (KR)

(21) Appl. No.: 14/339,673

(22) Filed: Jul. 24, 2014

(30) Foreign Application Priority Data
Jul. 26, 2013 (KR) 10-2013-0089055

(51) Int. Cl. H02P 6/14

(52) U.S. Cl. CPC H02P 6/14
USPC 318/400.21

(57) ABSTRACT

Disclosed herein are a parallel structure power apparatus and a control method thereof. There are provided a parallel structure power apparatus, including: an alternating current-direct current (AC-DC) converting unit, a main driving unit, a sub-driving unit, a temperature sensor unit measuring and outputting a temperature of the main driving unit and the sub-driving unit, and a controlling unit separately controlling the main driving unit or the sub-driving unit according to a state of the motor to rotate the motor and controlling the main driving unit or the sub-driving unit so that the main driving unit or the sub-driving unit which is being driven is turned off and the main driving unit or the sub-driving unit which is in a stop state is driven when the temperature measured by the temperature sensor unit becomes a predetermined temperature or more, and a control method thereof.

### CROSS REFERENCE TO RELATED APPLICATION

This application claims the benefit of Korean Patent Application No. 10-2013-0089055, filed on Jul. 26, 2013, entitled “Parallel Structure Power Apparatus and Control Method Thereof”, which is hereby incorporated by reference in its entirety into this application.

### BACKGROUND OF THE INVENTION

1. Technical Field

The present invention relates to a parallel structure power apparatus and a control method thereof.

2. Description of the Related Art

In general, a power apparatus generating high heat has been used in a motor driving apparatus. Due to this, in order to prevent the power apparatus from becoming a temperature higher than an operable temperature, a unit of cooling the power apparatus is provided (e.g., see Patent Document 1).

Patent Document 1 discloses a configuration in which a refrigerant cooler having a refrigerant flowing therein between an expansion valve of a refrigerant circuit and a heat exchanger of an exterior side contacts the power apparatus, and the power apparatus is cooled by the refrigerant flowing in the refrigerant cooler.

As a method different from that mentioned above, there is a method of driving a cooling fan by driving a cooling fan motor to thereby cool the power apparatus.

The above-mentioned two methods are efficient methods for preventing a temperature rise in the power apparatus. However, since they require much space to install the cooling apparatus, it is difficult to miniaturize the motor driving apparatus.

In addition, according to the prior art, since additional several electronic parts and mechanical parts are required to implement the cooling apparatus, it is difficult to decrease production cost in the motor driving apparatus.

Moreover, the above-mentioned methods according to the prior art may not be used in an environment having a spatial limitation in that an air cooling type fan or a water cooling type flow path may not be installed in the power apparatus of the motor driving apparatus.

### PRIOR ART DOCUMENT

### Patent Document

(Patent Document 1) Japanese Patent Laid-Open Publication No. 2010-25374

### SUMMARY OF THE INVENTION

The present invention has been made in an effort to provide a parallel structure power apparatus including two switch modules for each phase for one motor and is capable of being changed to another switch module when a temperature rise is sensed during use of any one switch module, and a control method thereof.

In addition, the present invention has been made in an effort to provide a parallel structure power apparatus including two switch modules for each phase for one motor and is capable of being changed to another switch module when a malfunction is sensed during use of any one switch module, and a control method thereof.

According to a preferred embodiment of the present invention, there is provided a parallel structure power apparatus, including: an alternating current-direct current (AC-DC) converting unit rectifying an alternating current power to thereby generate a direct current power; a main driving unit including a plurality of main switch modules corresponding to coils for each phase of a motor and allowing the main switch module to be switched by a control signal to provide the direct current power rectified by the AC-DC converting unit to the coil of each phase and to provide magnetic force generated by magnetic flux of the coil of each phase to a rotor; a sub-driving unit including a plurality of sub-switch modules corresponding to the coils for each phase of the motor and allowing the sub-switch module to be switched by the control signal to provide the direct current power rectified by the AC-DC converting unit to the coil of each phase and to provide the magnetic force generated by the magnetic flux of the coil of each phase to the rotor; a temperature sensor unit measuring and outputting a temperature of the main driving unit and the sub-driving unit; and a controlling unit separately controlling the main driving unit or the sub-driving unit according to a state of the motor to rotate the motor and controlling the main driving unit or the sub-driving unit so that the main driving unit or the sub-driving unit which is being driven is turned off and the main driving unit or the sub-driving unit which is in a stop state is driven when the temperature measured by the temperature sensor unit becomes a predetermined temperature or more.

The controlling unit may control the main driving unit or the sub-driving unit to thereby turn off the main driving unit or the sub-driving unit which is being driven and drive the main driving unit or the sub-driving unit which is in the stop state when a malfunction is found in the main driving unit or the sub-driving unit which is being driven during the rotation of the motor.

The main driving unit may be configured by a bridge circuit configured by the plurality of main switch modules for each phase connected to one another in parallel.

The plurality of main switch modules of the main driving unit may be configured so that a pair of main semiconductor switches configured each by main transistors are connected to each other in series, the pair of main semiconductor switches may have connection point which is an alternating current output portion, the connection point may be connected to a three-phase exciting winding of the motor which is star-connected, and each of the main transistors may be connected to each of main diodes in inverse-parallel.

The sub-driving unit may be configured by a bridge circuit configured by the plurality sub-switch modules for each phase connected to one another in parallel.

The plurality of sub-switch modules of the sub-driving unit may be configured so that a pair of sub-semiconductor switches configured each by sub-transistors are connected to each other in series, the pair of sub-semiconductor switches may have a connection point which is an alternating current output portion, the connection point may be connected to a three-phase exciting winding of the motor which is star-connected, and each of the sub-transistors may be connected to each of sub-diodes in inverse-parallel.

The plurality of main switch modules of the main driving unit, which are each turned on by the control signal to provide magnetic force generated by magnetic flux of the corresponding phase to the rotor, may be configured by a main upper switch and a main lower switch and turns on the main upper switch and the main lower switch according to the control signal to thereby provide the magnetic force generated by the magnetic flux of the corresponding phase to the rotor.

The main switch module of the main driving unit may include: a main upper semiconductor switch including a main upper transistor element connected to one side of the coil of the corresponding phase to intermit supply power according to the control signal input through a control terminal and a protection diode protecting the main upper transistor element from counter electromotive force generated from the coil of the corresponding phase at the time of turning on and off the main upper transistor element; and a main lower semiconductor switch including a main lower transistor element connected to the other side of the coil of the corresponding phase to intermit supply power according to the control signal input through the control terminal and a protection diode protecting the main lower transistor element from counter electromotive force generated from the coil of the corresponding phase at the time of turning on and off the main lower transistor element.

The sub-switch modules of the sub-driving unit, which are each turned on by the control signal to provide magnetic force generated by magnetic flux of the corresponding phase to the rotor, may be configured by a sub-upper switch and a sub-lower switch and turns on the sub-upper switch and the sub-lower switch according to the control signal to thereby provide the magnetic force generated by the magnetic flux of the corresponding phase to the rotor.

The sub-switch module of the sub-driving unit may include: a sub-upper semiconductor switch including a sub-upper transistor element connected to one side of the coil of the corresponding phase to intermit supply power according to the control signal input through a control terminal and an upper protection diode protecting the sub-upper transistor element from counter electromotive force generated from the coil of the corresponding phase at the time of turning on and off the sub-upper transistor element; and a sub-lower semiconductor switch including a sub-lower transistor element connected to the other side of the coil of the corresponding phase to intermit supply power according to the control signal input through the control terminal and a protection diode protecting the sub-lower transistor element from counter electromotive force generated from the coil of the corresponding phase at the time of turning on and off the sub-lower transistor element.

According to another preferred embodiment of the present invention, there is provided a parallel structure power apparatus, including: an alternating current-direct current (AC-DC) converting unit rectifying an alternating current power to thereby generate a direct current power; a main driving unit including a plurality of main switch modules including a pair of main switches corresponding to coils for each phase of a motor and allowing the main switch module to be switched by a control signal to provide the direct current power rectified by the AC-DC converting unit to the coil of each phase and to provide magnetic force generated by magnetic flux of the coil of each phase to a rotor; a sub-driving unit including a plurality of sub-switch modules including a pair of sub-switches corresponding to the coils for each phase of the motor and allowing the sub-switch module to be switched by the control signal to provide the direct current power rectified by the AC-DC converting unit to the coil of each phase and to provide the magnetic force generated by the magnetic flux of the coil of each phase to the rotor; a temperature sensor unit measuring and outputting a temperature of each of the main switches of the plurality of main switch modules of the main driving unit and a temperature of each of the sub-switches of the plurality of sub-switch modules of the sub-driving unit; and a controlling unit separately controlling the main driving unit or the sub-driving unit according to a state of the motor to rotate the motor and controlling the main driving unit or the sub-driving unit so that a corresponding main switch in the main switch module of the main driving unit or the sub-switch in the sub-switch module of the sub-driving unit which is being driven at a measured temperature of a predetermined temperature or more is turned off and the main switch in the main switch module of the main driving unit or the sub-switch in the sub-switch module of the sub-driving unit which is in a corresponding stop state is driven in the case in which the measured temperature of the predetermined temperature or more is found among the measured temperatures of the respective main switches of the plurality of main switch modules and the respective sub-switches of the sub-switch modules measured by the temperature sensor unit.

According to another preferred embodiment of the present invention, there is provided a parallel structure power apparatus, including: an alternating current-direct current (AC-DC) converting unit rectifying an alternating current power to thereby generate a direct current power; a main driving unit including a plurality of main switch modules corresponding to coils for each phase of a motor and allowing the main switch module to be switched by a control signal to provide the direct current power rectified by the AC-DC converting unit to the coil of each phase and to provide magnetic force generated by magnetic flux of the coil of each phase to a rotor; a sub-driving unit including a plurality of sub-switch modules corresponding to the coils for each phase of the motor and allowing the sub-switch module to be switched by the control signal to provide the direct current power rectified by the AC-DC converting unit to the coil of each phase and to provide the magnetic force generated by the magnetic flux of the coil of each phase to the rotor; and a controlling unit controlling the main driving unit or the sub-driving unit according to a state of the motor to rotate the motor and turning off the main driving unit or the sub-driving unit which is being driven and driving the main driving unit or the sub-driving unit which is in a stop state when a malfunction is found in the main driving unit or the sub-driving unit which is being driven.

The main driving unit may be configured by a bridge circuit configured by the plurality of main switch modules for each phase connected to one another in parallel, and the sub-driving unit may be configured by a bridge circuit configured by the plurality sub-switch modules for each phase connected to one another in parallel.

The plurality of main switch modules of the main driving unit, which are each turned on by the control signal to provide magnetic force generated by magnetic flux of the corresponding phase to the rotor, may be configured by a main upper switch and a main lower switch and turns on the main upper switch and the main lower switch according to the control signal to thereby provide the magnetic force generated by the magnetic flux of the corresponding phase to the rotor, and the plurality of sub-switch modules of the sub-driving unit, which are each turned on by the control signal to provide magnetic force generated by magnetic flux of the corresponding phase to the rotor, may be configured by a sub-upper switch and a sub-lower switch and turns on the sub-upper switch and the sub-lower switch according to the control signal to thereby provide the magnetic force generated by the magnetic flux of the corresponding phase to the rotor.

According to another preferred embodiment of the present invention, there is provided a control method of a parallel structure power apparatus, the control method including: converting, by an alternating current-direct current (AC-DC) converting unit, an alternating current power into a direct current power and providing the converted direct current power; generating, by a controlling unit, a control signal according to a state of a motor to control a main driving unit or a sub-driving unit; measuring and outputting, by a temperature sensor unit, a temperature of the main driving unit or the sub-driving unit; and changing and operating, by the controlling unit, the main driving unit or the sub-driving unit which is being driven to the main driving unit or the sub-driving unit which is in a stop state when the temperature of the main driving unit or the sub-driving unit measured by the temperature sensor unit is a predetermined temperature or more.

The changing and operating of the main driving unit or the sub-driving unit may include: measuring and transmitting, by the temperature sensor unit, the temperature of the main driving unit or the sub-driving unit; determining, by the controlling unit, whether or not the temperature measured by the temperature sensor unit is the predetermined temperature or more; and changing and operating, by the controlling unit, the main driving unit or the sub-driving unit which is being driven to the main driving unit or the sub-driving unit which is in the stop state when the temperature is the predetermined temperature or more based on the determination.

The control method may further include changing and operating, by the controlling unit, the main driving unit or the sub-driving unit which is being driven to the main driving unit or the sub-driving unit which is in the stop state when a malfunction is found in the main driving unit or the sub-driving unit which is being driven.

The control method may further include turning off, by the controlling unit, a corresponding switch module of the main driving unit or a corresponding switch module of the sub-driving unit which is being driven, and changing and operating the corresponding switch module of the main driving unit or the corresponding switch module of the sub-driving unit to the corresponding main switch module of the main driving unit or the corresponding switch module of the sub-driving unit which is in the stop state when a malfunction is found in the respective switch modules of the main driving unit or the respective switch modules of the sub-driving unit which is being driven.

According to another preferred embodiment of the present invention, there is provided a control method of a parallel structure power apparatus, the control method including: converting, by an alternating current-direct current (AC-DC) converting unit, an alternating current power into a direct current power and providing the converted direct current power; generating, by a controlling unit, a control signal according to a state of a motor to control a main driving unit or a sub-driving unit; measuring and outputting, by a temperature sensor unit, a temperature of each of main switches of a plurality of main switch modules of the main driving unit and a temperature of each of sub-switches of a plurality of sub-switch modules of the sub-driving unit; and turning off, by the controlling unit, a corresponding main switch in the main switch module of the main driving unit or a sub-switch in the sub-switch module of the sub-driving unit which is being driven at a measured temperature of a predetermined temperature or more and driving the main switch in the main switch module of the main driving unit or the sub-switch in the sub-switch module of the sub-driving unit which is in a corresponding stop state in the case in which the measured temperature of the predetermined temperature or more is found among the measured temperatures of the respective main switches of the plurality of main switch modules and the respective sub-switches of the sub-switch modules measured by the temperature sensor unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a parallel structure power apparatus according to a preferred embodiment of the present invention;

FIG. 2 is a detailed configuration diagram of a main driving unit and a sub-driving unit in the case in which a motor of FIG. 1 is a BLDC motor;

FIG. 3 shows an operation of a main switch module and a waveform of a signal supplied to a coil according to the operation of the main switch module;

FIG. 4 shows an operation of a sub-switch module and a waveform of a signal supplied to a coil according to the operation of the sub-switch module;

FIG. 5 is a detailed configuration diagram of a main driving unit and a sub-driving unit in the case in which the motor of FIG. 1 is an SRM motor; and

FIG. 6 is a flow chart of a control method of a parallel structure power apparatus according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

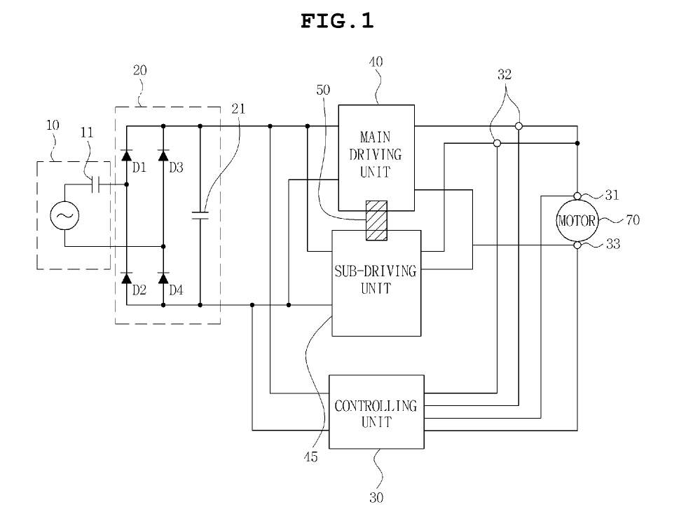

FIG. 1 is a configuration diagram of a parallel structure power apparatus according to a preferred embodiment of the present invention.

Referring to FIG. 1, the parallel structure power apparatus according to the preferred embodiment of the present invention is configured to include a power unit 10, a direct current-alternating current (DC-AC) converting unit 20, a controlling unit 30, a main driving unit 40, a sub-driving unit 45, and a temperature sensor unit 50.

The power unit 10, which is a member dropping a general commercial alternating current power to transfer the dropped alternating current power to the DC-AC converting unit 20 and the controlling unit 30, includes a charging and discharging capacitor 11 for supply power to the DC-AC converting unit 20 to this end.

The DC-AC converting unit 20, which is a member receiving the dropped alternating current power from the power unit 10 to convert it to a direct current power, includes bridge diodes D1, D2, D3, and D4 full-wave rectifying the alternating current power and a smoothing capacitor 21 removing a pulsation component remained in the rectified power.

In addition, the main driving unit 40 includes each main switch module for a coil for each phase in order to provide a driving signal to the coil for each phase of a motor 70.

The main driving unit 40 converts the direct current power supplied from the AC-DC converting unit 20 into a three phase alternating current power (typically configured by a U phase, a V phase, and a W phase) of a pulse form having any variable frequency and supplies it to the motor 70.

A main switch module of the main driving unit 40 is mainly configured by a switch element, where the switch element is a metal oxide semiconductor field effect transistor (MOSFET), an IGBT, and the like.

The main switch module of the main driving unit 40 having the above-mentioned configuration is responsive to a pulse width modulation (PWM) control signal of on/off form provided from the controlling unit 30 to thereby serve to supply an amplified pulse width modulation signal having the same timing as the PWM control signal to the coil for each corresponding phase of the motor 70 as a driving signal.

Next, the sub-driving unit 45 each includes a sub-switch module for a coil for each phase in order to provide a driving signal to the coil for each phase of a motor 70.

In addition, the sub-driving unit 45 converts the direct current power supplied from the AC-DC converting unit 20 into a three phase alternating current power (typically configured by a U phase, a V phase, and a W phase) of a pulse form having any variable frequency and supplies it to the motor 70.

A sub-switch module of the sub-driving unit 45 is mainly configured by a switch element, where the switch element is a metal oxide semiconductor field effect transistor (MOSFET), an IGBT, and the like.

The sub-switch module of the main driving unit 45 having the above-mentioned configuration is responsive to a pulse width modulation (PWM) control signal of on/off form provided from the controlling unit 30 to thereby serve to supply an amplified pulse width modulation signal having the same timing as the PWM control signal to the coil for each corresponding phase of the motor 70 as a driving signal.

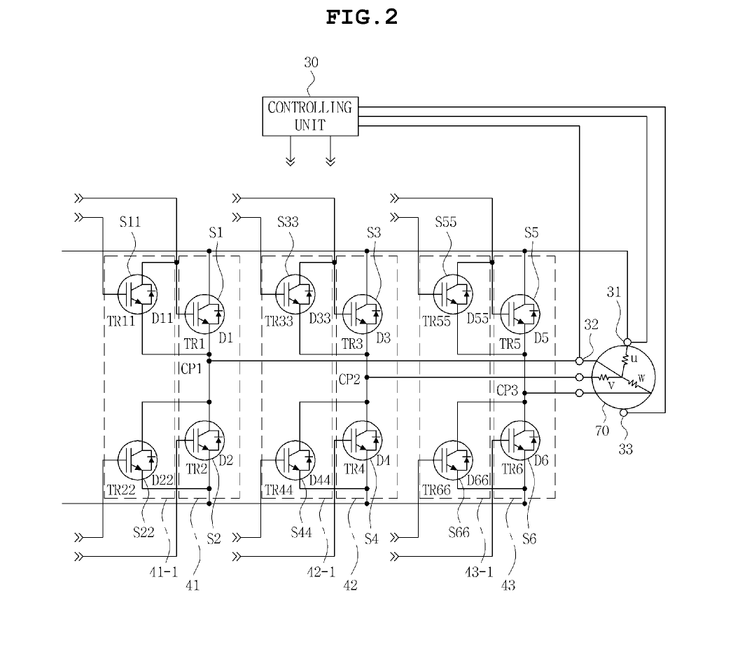

In the case in which the motor 70 is a BLDC motor, detailed configurations of the main driving unit 40 and the sub-driving unit 45 are shown in FIG. 2. Operations of the main driving unit 40 and the sub-driving unit 45 will be described with reference to FIG. 2.

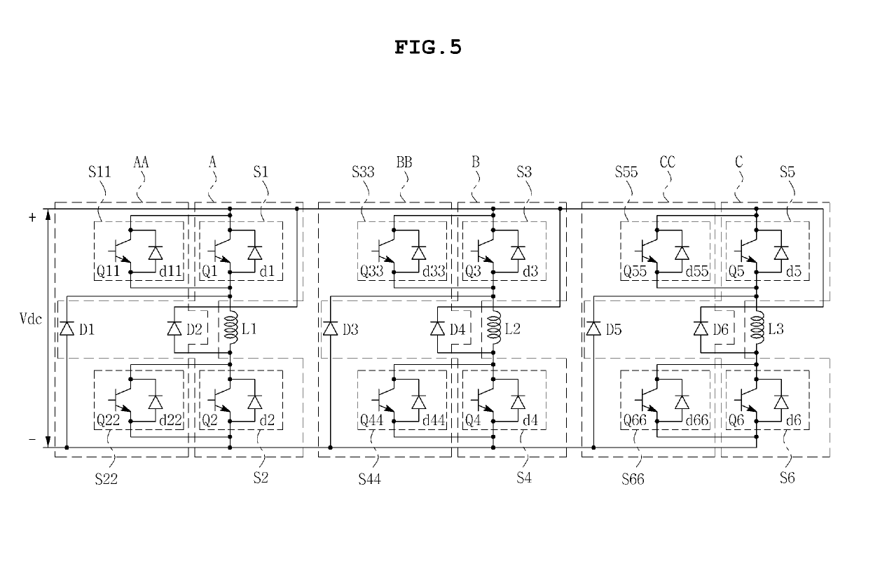

In addition, in the case in which the motor 70 is an SRM motor, detailed configurations of the main driving unit 40 and the sub-driving unit 45 are shown in FIG. 5. Operations of the main driving unit 40 and the sub-driving unit 45 will be described with reference to FIG. 5.

Next, the controlling unit 30 may drive the motor 70 using any one of the main driving unit 40 and the sub-driving unit 45.

That is, the controlling unit 30 senses a speed and a position of a rotor of the motor 70, and the like from a position sensor unit 31, a current sensor unit 32, and a speed sensor unit 33, and generates a control signal accordingly to thereby control any one of the main driving unit 40 and the sub-driving unit 45, thereby making it possible to drive the motor 70.

In addition, the controlling unit 30 turns off the driving unit 40 or 45 which is being driven when a predetermined temperature or more is sensed by the temperature sensor unit 50 and drives another driving unit 40 or 45, thereby preventing the temperature rise in the power apparatus and an element.

In addition, the controlling unit 30 drives another driving unit 40 or 45 when the malfunction of the driving unit 40 or 45 is sensed during an operation of any one driving unit 40 or 45 among two driving units 40 and 45 which are the main driving unit 40 and the sub-driving unit 45, based on a current sensed by the current sensor unit 32 (in the case in which an abnormal operation is generated, such as the case in which a current value becomes a predetermined value or more, or becomes blow a predetermined value, the case in which an amplitude of the current becomes a predetermined value or more, and the like) to thereby allow the motor 70 to be continuously driven at the time of the malfunction generation.

The controlling unit 30 performing the above-mentioned control includes the position sensor unit 31 measuring the speed of the motor 70 to thereby generate the pulse width modulation control signal to allow the motor 70 to be rotated at an appropriate speed and provide the generated pulse width modulation control signal to a switch element of the switch module of the driving units 40 and 45.

Meanwhile, the temperature sensor unit 50 detects a temperature of the driving units 40 and 45 and provides the detected temperature to the controlling unit 30.

In the case in which the sensed temperature by the temperature sensor unit 50 is a predetermined temperature or more during the providing of the driving signal to the coil for each phase using any one of the main driving unit 40 and the sub-driving unit 45, another driving unit 40 or 45 among the two driving units 40 and 45 is driven and an operation of the driving unit 40 or 45 which is previously operated is stopped, thereby making it possible to prevent the temperature rise in the power apparatus.

In addition, in the case in which the malfunction of the driving unit 40 or 45 is sensed while being operated using any one of the main driving unit 40 and the sub-driving unit 45, another driving unit 40 or 45 is driven, thereby making it possible to allow the motor 70 to be continuously driven at the time of the malfunction generation.

As a result, according to the preferred embodiment of the present invention described above, the power apparatus may be easily cooled in an environment having a spatial limitation in that an air cooling type fan or a water cooling type flow path may not be installed.

In addition, according to the preferred embodiment of the present invention, the temperature rise in the power apparatus may be prevented even without including the additional cooling apparatus, thereby making it possible to miniaturize the motor driving apparatus.

In addition, according to the preferred embodiment of the present invention, the temperature rise in the power apparatus may be prevented even without including the additional cooling apparatus, thereby making it possible to decrease production cost of the motor driving apparatus.

Moreover, according to the preferred embodiment of the present invention, the two switch modules for each phase for one motor are included to be changed to another switch module during the use of any one switch module, such that the motor driving state may be easily maintained when the malfunction is generated in the switch module.

FIG. 2 is a detailed configuration diagram of a main driving unit and a sub-driving unit in the case in which a motor of FIG. 1 is a BLDC motor. Here, the BLDC motor includes an interior permanent magnet type BLDC motor having a permanent magnet inserted into the rotor, a surface permanent magnet type BLDC motor having the permanent magnet attached on a surface of the rotor, and the like.

Referring to FIG. 2, the main driving unit of FIG. 1 is configured by a bridge circuit configured by the main switch modules 41 to 43 for each phase connected with one another in parallel.

The main switch modules 41 to 43 are configured so that a pair of main semiconductor switches (S1 and S2, S3 and S4, and S5 and S6) each configured by transistors (TR1, TR2, TR3, TR4, TR5, and TR6) are connected with each other in series.

In addition, connection points CP1 to CP3 between the pair of main semiconductor switches (S1 and S2, S3 and S4, and S5 and S6) form alternating current outputting units.

The connection points CP1 to CP3 are connected to a three-phase exciting winding U, V, and W of the motor 70 which is star-connected. The six main transistors TR1 to TR6 used in the main driving unit 40 have main diodes D1 to D6 each connected thereto in inverse-parallel.

In present preferred embodiment, the main driving unit 40 is PWM-controlled based on the PWM control signal output from the controlling unit 30 to thereby convert direct current power into alternating current power and output the converted alternating current power.

In addition, the controlling unit 30 detects the speed and the position of the rotor of the motor 70 based on the output from the position sensor unit 31, the current sensor unit 32, and the speed sensor unit 33 at an output side of the motor 70 and controls the position and the speed of the rotor of the motor 70 based on detected information.

Meanwhile, the sub-driving unit 45 is configured by a bridge circuit configured by sub-switch modules 41-1 to 43-1 for each phase connected with one another in parallel.

The sub-switch modules 41-1 to 43-1 are configured so that a pair of sub-semiconductor switches (S11 and S22, S33 and S44, and S55 and S66) each configured by transistors (TR11, TR22, TR33, TR44, TR55, and TR66) are connected with each other in series.

In addition, the connection points CP1 to CP3 between the pair of sub-semiconductor switches (S11 and S22, S33 and S44, and S55 and S66) form the alternating current outputting units.

The connection points CP1 to CP3 are connected to a three-phase exciting winding U, V, and W of the motor 70 which is star-connected. The six sub-transistors TR11 to TR66 used in the sub-driving unit 45 have sub-diodes D11 to D66 each connected thereto in inverse-parallel.

Next, the controlling unit 30 may drive the motor 70 using any one of the main switch module of the main driving unit 40 and the sub-switch module of the sub-driving unit 45.

In addition, the controlling unit 30 turns off the switch module of the driving unit 40 or 45 which is being driven when a predetermined temperature or more is sensed by the temperature sensor unit 50 and drives the switch module of another driving unit 40 or 45, thereby preventing the temperature rise in the power apparatus.

In addition, the controlling unit 30 drives the switch module of another driving unit 40 or 45 when the malfunction of the switch module of the driving unit 40 or 45 is sensed during an operation of the switch module of any one driving unit 40 or 45 among the two driving units 40 and 45 which are the main driving unit 40 and the sub-driving unit 45 to thereby allow the motor 70 to be continuously driven at the time of the malfunction generation.

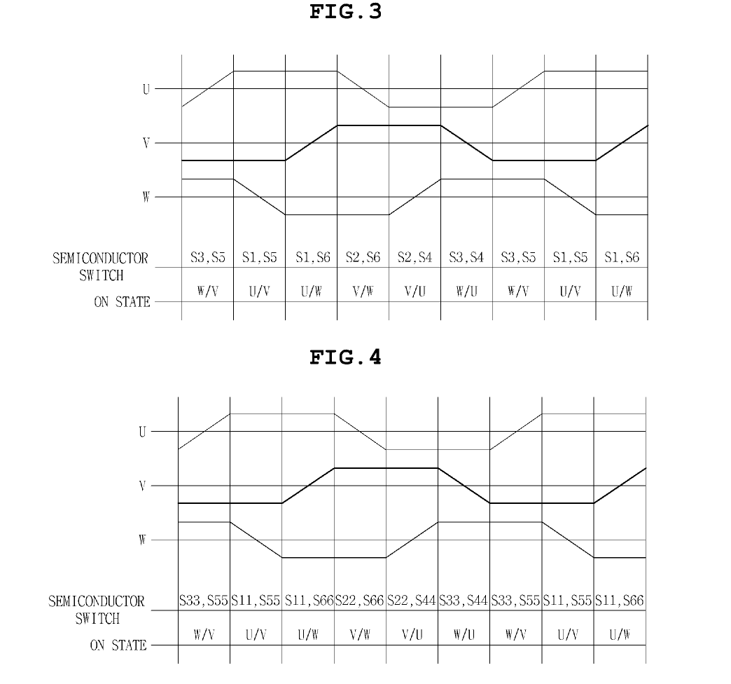

In relation to this, FIG. 3 shows an operation of a main switch module and a waveform of a signal supplied to a coil according to the operation of the main switch module and FIG. 4 shows an operation of a sub-switch module and a waveform of a signal supplied to a coil according to the operation of the sub-switch module.

As shown in FIGS. 3 and 4, even though the main switch module is turned off and the sub-switch module is turned on, the current supplied to the coil is equal, such that it is not difficult to continuously control the motor 70.

As a result, according to the preferred embodiment of the present invention as described above, in the power apparatus of the BLDC motor, the power apparatus may be easily used in the environment having a spatial limitation in that the air cooling type fan or the water cooling type flow path may not be installed.

In addition, according to the preferred embodiment of the present invention, in the power apparatus of the BLDC motor, the temperature rise in the power apparatus may be prevented even without including the additional cooling apparatus, thereby making it possible to miniaturize the motor driving apparatus.

In addition, according to the preferred embodiment of the present invention, in the power apparatus of the BLDC motor, the temperature rise in the power apparatus may be prevented even without including the additional cooling apparatus, thereby making it possible to decrease production cost of the motor driving apparatus.

Moreover, according to the preferred embodiment of the present invention, in the power apparatus of the BLDC motor, the two switch modules for each phase for one motor are included to be changed to another switch module during the use of any one switch module, such that the motor driving state may be easily maintained when the malfunction is generated in the switch module.

FIG. 5 is a detailed configuration diagram of a main driving unit and a sub-driving unit in the case in which the motor of FIG. 1 is an SRM motor.

Referring to FIG. 5, the main driving unit of FIG. 1 is configured by a first main switch module A, a second main switch module B, and a third main switch module C.

Here, the first main switch module A, which is turned on by a control signal to thereby provide magnetic force generated by magnetic flux of a first phase to the rotor, is configured by a first main upper switch S1 and a first main lower switch S2, and turns on the first main upper switch S1 and the first main lower switch S2 according to the control signal to thereby provide the magnetic force generated by the magnetic flux of the corresponding phase to the rotor.

In addition, the first main switch module A includes a first current feedback diode D1 and a second current feedback diode D2 performing a current feedback in a first phase coil.

In addition, the second main switch module B, which is turned on by the control signal to thereby provide the magnetic force generated by the magnetic flux of a second phase to the rotor, is configured by a second main upper switch S3 and a second main lower switch S4, and turns on the second main upper switch S3 and the second main lower switch S4 according to the control signal to thereby provide the magnetic force generated by the magnetic flux of the corresponding phase to the rotor.

In addition, the second main switch module B includes a third current feedback diode D3 and a fourth current feedback diode D4 performing the current feedback in a second phase coil.

Meanwhile, the third main switch module C, which is turned on by the control signal to thereby provide the magnetic force generated by the magnetic flux of a third phase to the rotor, is configured by a third main upper switch S5 and a third main lower switch S6, and turns on the third main upper switch S5 and the third main lower switch S6 according to the control signal to thereby provide the magnetic force generated by the magnetic flux of the corresponding phase to the rotor.

In addition, the third main switch module C includes a fifth current feedback diode D5 and a sixth current feedback diode D6 performing the current feedback in a third phase coil.

Here, the first main upper switch S1 includes a first main upper transistor element Q1 connected to one side of a first phase coil L1 generating the magnetic flux of the first phase to thereby intermit supply power according to the control signal input through a control terminal, and a first main upper protection diode d1 protecting the first main upper transistor element Q1 from counter electromotive force generated from the first phase coil L1 at the time of turning on and off the first main upper transistor element Q1.

In addition, the first main lower switch S2 includes a first main lower transistor element Q2 connected to the other side of the first phase coil L1 to thereby intermit supply power according to the control signal input through the control terminal, and a first main lower protection diode d2 protecting the first main lower transistor element Q2 from counter electromotive force generated from the first phase coil L1 at the time of turning on and off the first main lower transistor element Q2.

In addition to this, a second main upper switch S3, a second main lower switch S4, a third main upper switch S5, and a third main lower switch S6 also have a structure similar to that described above. A detailed description thereof will be omitted.

Meanwhile, the sub-driving unit is configured by a first sub-switch module AA, a second sub-switch module BB, and a third sub-switch module CC.

Here, the first sub-switch module AA, which is turned on by a control signal to thereby provide magnetic force generated by magnetic flux of a first phase to the rotor, is configured by a first sub-upper switch S11 and a first sub-lower switch S22, and turns on the first sub-upper switch S11 and the first sub-lower switch S22 according to the control signal to thereby provide the magnetic force generated by the magnetic flux of the corresponding phase to the rotor.

In addition, the first sub-switch module AA shares the first current feedback diode D1 and the second current feedback diode D2 performing the current feedback in the first phase coil with the first main switch module A.

In addition, the second sub-switch module BB, which is turned on by the control signal to thereby provide the magnetic force generated by the magnetic flux of a second phase to the rotor, is configured by a second sub-upper switch S33 and a second sub-lower switch S44, and turns on the second sub-upper switch S33 and the second sub-lower switch S44 according to the control signal to thereby provide the magnetic force generated by the magnetic flux of the corresponding phase to the rotor.

In addition, the second sub-switch module BB shares the third current feedback diode D3 and fourth current feedback diode D4 performing the current feedback in the second phase coil with the second main switch module B.

Meanwhile, the third sub-switch module CC, which is turned on by the control signal to thereby provide the magnetic force generated by the magnetic flux of a third phase to the rotor, is configured by a third sub-upper switch S55 and a third sub-lower switch S66, and turns on the third sub-upper switch S55 and the third sub-lower switch S66 according to the control signal to thereby provide the magnetic force generated by the magnetic flux of the corresponding phase to the rotor.

In addition, the third sub-switch module CC shares the fifth current feedback diode D5 and the sixth current feedback diode D6 performing the current feedback in the third phase coil with the third main switch module C.

Here, the first sub-upper switch S11 includes a first sub-upper transistor element Q11 connected to one side of the first phase coil L1 generating the magnetic flux of the first phase to thereby intermit supply power according to the control signal input through the control terminal, and a first sub-upper protection diode d11 protecting the first sub-upper transistor element Q11 from counter electromotive force generated from the first phase coil L1 at the time of turning on and off the first sub-upper transistor element Q11.

In addition, the first sub-lower switch S22 includes a first sub-lower transistor element Q22 connected to the other side of the first phase coil L1 to thereby intermit supply power according to the control signal input through the control terminal, and a first sub-lower protection diode d22 protecting the first sub-lower transistor element Q22 from counter electromotive force generated from the first phase coil L1 at the time of turning on and off the first sub-lower transistor element Q22.

In addition to this, a second sub-upper switch S33, a second sub-lower switch S44, a third sub-upper switch S55, and a third sub-lower switch S66 also have a structure similar to that described above. A detailed description thereof will be omitted.

An operation of the main driving unit and the sub-driving unit will be described as follows.

The controlling unit varies an excited state for each phase of a stator to thereby rotate the rotor of a switched reluctance motor in a desired direction by switching the first main switch module A, the second main switch module B, and the third main switch module C based on relative position information of the rotor for a multiphase stator.

In this case, the controlling unit varies the excited state for each phase of the stator to thereby continuously rotate the rotor of the switched reluctance motor in the desired direction by turning off the first main switch module A, the second main switch module B, and the third main switch module C, and switching the first sub-switch module AA, the second sub-switch module BB, and the third sub-switch module CC in the case in which the temperature measured by the temperature sensor unit becomes the predetermined temperature or more.

Of course, in this situation, the controlling unit varies the excited state for each phase of the stator to thereby continuously rotate the rotor of the switched reluctance motor in the desired direction by turning off the first sub-switch module AA, the second sub-switch module BB, and the third sub-switch module CC, and switching the first main switch module A, the second main switch module B, and the third main switch module C in the case in which the temperature measured by the temperature sensor unit becomes the predetermined temperature or more.

Meanwhile, the controlling unit varies an excited state for each phase of a stator to thereby rotate the rotor of a switched reluctance motor in a desired direction by switching the first main switch module A, the second main switch module B, and the third main switch module C based on relative position information of the rotor for a multiphase stator.

In this case, the controlling unit varies the excited state for each phase of the stator to thereby continuously rotate the rotor of the switched reluctance motor in the desired direction by turning off the first main switch module A, the second main switch module B, and the third main switch module C, and switching the first sub-switch module AA, the second sub-switch module BB, and the third sub-switch module CC in the case in which the current by the current sensor unit does not have an expected current value (as an example, in the case in which the current becomes a predetermined value or more and an excess current flows, the current becomes the predetermined or less and a low current flows, or a change in the amplitude becomes a predetermined value or more and a peak current is generated).

Conversely, while the controlling unit varies the excited state for each phase of the stator to thereby continuously rotate the rotor of the switched reluctance motor in the desired direction by switching the first sub-switch module AA, the second sub-switch module BB, and the third sub-switch module CC based on the relative position information of the rotor for the multiphase stator, the controlling unit varies the excited state for each phase of the stator to thereby continuously rotate the rotor of the switched reluctance motor in the desired direction by turning off the first sub-switch module AA, the second sub-switch module BB, and the third sub-switch module CC and switching the first main switch module A, the second main switch module B, and the third main switch module C in the case in which the current by the current sensor unit does not have an expected current value (as an example, in the case in which the current becomes a predetermined value or more or the predetermined value or less, or a change in the amplitude becomes a predetermined value or more).

Here, in the case in which the malfunction is generated in any one switch module of the main driving unit, the present invention is implemented so that the main driving unit is changed and operated to the sub-driving unit, but it is also possible to change and operate the main switch to the sub-switch (and vice versa) so that the main switch module is changed and operated to the sub-switch module (and vice versa) (i.e., i) the entire main switch module of the main driving unit may be turned off and the entire sub-switch module of the sub-driving unit may be operated, ii) only the corresponding main switch module in which the malfunction is generated among the main driving unit may be turned off and only the corresponding sub-switch module of the sub-driving unit corresponding thereto may be operated, or iii) only the main switch in which the malfunction is generated in the main switch module of the main driving unit may be turned off and only the corresponding sub-switch in the sub-switch module of the sub-driving unit corresponding thereto may be operated).

Meanwhile, the present invention is implemented so that the main driving unit and the sub-driving unit are changed and operated, but is not limited thereto. When the temperature sensor unit measures and outputs each of the temperature of a plurality of main switch modules of the main driving unit and the temperature of a plurality of sub-switch modules of the sub-driving unit, the controlling unit may control so that the main switch module of the main driving unit or the sub-switch module of the sub-driving unit which is being driven at a measured temperature of a predetermined temperature or more is turned off and the main switch module of the main driving unit or the sub-switch module of the sub-driving unit of a corresponding stop state is driven in the case in which the measured temperature of the predetermined temperature or more is found among the measured temperatures of the plurality of main switch modules and sub-switch modules measured by the temperature sensor unit.

In addition, the temperature sensor unit according to the preferred embodiment of the present invention measures and outputs each of the temperature of the respective main switches of the plurality of main switch modules of the main driving unit and the temperature of the respective sub-switches of the plurality of sub-switch modules of the sub-driving unit, and the controlling unit controls so that the corresponding main switch in the main switch module of the main driving unit or the sub-switch in the sub-switch module of the sub-driving unit which is being driven at a measured temperature of a predetermined temperature or more is turned off and the main switch in the main switch module of the main driving unit or the sub-switch in the sub-switch module of the sub-driving unit of a corresponding stop state is driven in the case in which the measured temperature of the predetermined temperature or more is found among the measured temperatures of the respective main switches of the plurality of main switch modules and the respective sub-switches of the sub-switch modules measured by the temperature sensor unit.

According to the preferred embodiment of the present invention as described above, in the power apparatus of the SRM motor, the power apparatus may be easily cooled in the environment having a spatial limitation in that the air cooling type fan or the water cooling type flow path may not be installed.

In addition, according to the preferred embodiment of the present invention, in the power apparatus of the SRM motor, the temperature rise in the power apparatus may be prevented even without including the additional cooling apparatus, thereby making it possible to miniaturize the motor driving apparatus.

In addition, according to the preferred embodiment of the present invention, in the power apparatus of the SRM motor, the temperature rise in the power apparatus may be prevented even without including the additional cooling apparatus, thereby making it possible to decrease production cost of the motor driving apparatus.

Moreover, according to the preferred embodiment of the present invention, in the power apparatus of the SRM motor, the two switch elements for each phase for one motor are included to be changed to another switch element during the use of any one switch element, such that the motor driving state may be easily maintained when the malfunction is generated in the switch element.

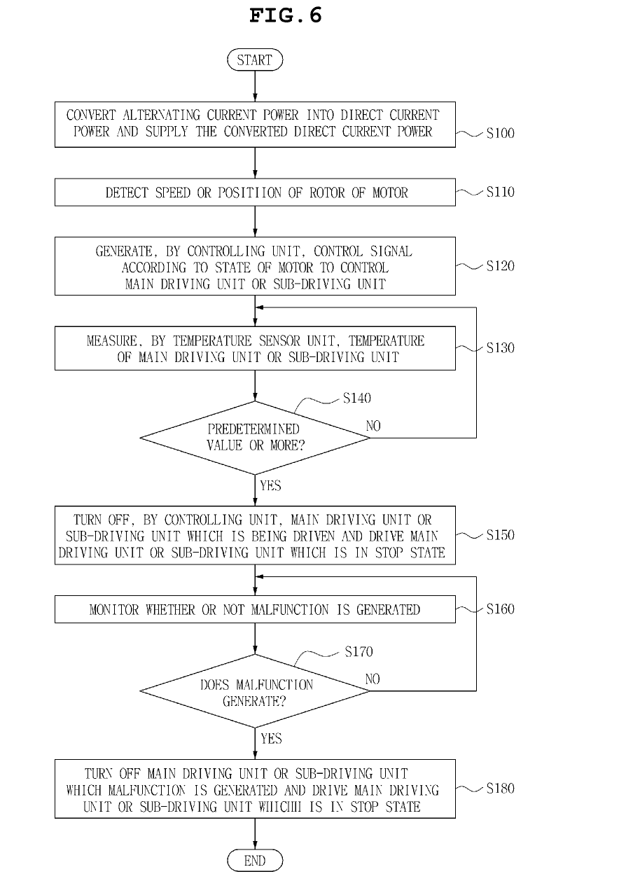

FIG. 6 is a flow chart of a control method of a parallel structure power apparatus according to a preferred embodiment of the present invention.

First, the DC-AC converting unit converts the alternating current power supplied by the power unit into the direct current power to thereby provide the direction power to the main driving unit, the sub-driving unit, and the controlling unit (S100).

In addition, the controlling unit detects the speed or the position of the rotor of the motor using the position sensor unit, the speed sensor unit, the current sensor unit, and the like installed in the motor (S110).

Next, the controlling unit generates the control signal according to the motor state such as the detected speed or position of the rotor of the motor to thereby control the main driving unit or the sub-driving unit, thereby generating the driving signal (S120).

In this case, the controlling unit may first control the main driving unit to generate the driving signal.

Next, when the temperature sensor unit measures and transmits the temperature of the main driving unit or the sub-driving unit (S130), the controlling unit determines whether or not the temperature measured by the temperature sensor unit is the predetermined temperature or more (S140).

As a result of the determination, when the temperature measured by the temperature sensor unit becomes the predetermined temperature or more, the main driving unit or the sub-driving unit which is being driven is turned off and the main driving unit or the sub-driving unit which is in the stop state is driven (S150).

That is, the controlling unit turns off the main driving unit and drives the sub-driving unit when the main driving unit is driving. Conversely, the controlling unit turns off the sub-driving unit and drives the main driving unit when the sub-driving unit is driving.

Of course, according to the present invention, when the temperature sensor unit measures and outputs each of the temperature of the plurality of main switch modules of the main driving unit and the temperature of the plurality of sub-switch modules of the sub-driving unit, the controlling unit may control so that the main switch module of the main driving unit or the sub-switch module of the sub-driving unit which is being driven at the measured temperature of the predetermined temperature or more is turned off and the main switch module of the main driving unit or the sub-switch module of the sub-driving unit of a corresponding stop state is driven in the case in which the measured temperature of the predetermined temperature or more is found among the measured temperatures of the plurality of main switch modules and sub-switch modules measured by the temperature sensor unit.

In addition, the temperature sensor unit according to the preferred embodiment of the present invention measures and outputs each of the temperature of the respective main switches of the plurality of main switch modules of the main driving unit and the temperature of the respective sub-switches of the plurality of sub-switch modules of the sub-driving unit, and the controlling unit may control so that the corresponding main switch in the main switch module of the main driving unit or the sub-switch in the sub-switch module of the sub-driving unit which is being driven at the measured temperature of the predetermined temperature or more is turned off and the main switch in the main switch module of the main driving unit or the sub-switch in the sub-switch module of the sub-driving unit of the corresponding stop state is driven in the case in which the measured temperature of the predetermined temperature or more is found among the measured temperatures of the respective main switches of the plurality of main switch modules and the respective sub-switches of the sub-switch modules measured by the temperature sensor unit.

Meanwhile, the controlling unit monitors whether or not the malfunction is generated in the main driving unit or the sub-driving unit using the current sensor unit or the like (S160).

Next, when the malfunction is generated in the main driving unit or the sub-driving unit (S170), the controlling unit turns off the main driving unit or the sub-driving unit in which the malfunction is generated and drives the main driving unit or the sub-driving unit which is in the stop state (S180).

Of course, in this case, the controlling unit monitors whether or not the malfunction is generated in the respective switch modules of the main driving unit or the respective switch modules of the sub-driving unit, and in the case in which the malfunction is generated in the switch module of the main driving unit or the switch module of the sub-driving unit, may turn off the switch module of the main driving unit or the switch module of the sub-driving unit in which the malfunction is generated, and may control the corresponding switch module of the main driving unit or the corresponding switch module of the sub-driving unit which is in the stop state, thereby generating the driving signal.

According to the preferred embodiment of the present invention, the power apparatus may be easily used in the environment having a spatial limitation in that the air cooling type fan or the water cooling type flow path may not be installed.

In addition, according to the preferred embodiment of the present invention, the temperature rise in the power apparatus may be prevented even without including the additional cooling apparatus, thereby making it possible to miniaturize the motor driving apparatus.

In addition, according to the preferred embodiment of the present invention, the temperature rise in the power apparatus may be prevented even without including the additional cooling apparatus, thereby making it possible to decrease production cost of the motor driving apparatus.

Moreover, according to the preferred embodiment of the present invention, the two switch modules for each phase for one motor are included to be changed to another switch module during the use of any one switch module, such that the motor driving state may be easily maintained when the malfunction is generated in the switch module.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A parallel structure power apparatus, comprising:
an alternating current-direct current (AC-DC) converting unit rectifying an alternating current power to thereby generate a direct current power;
a main driving unit including a plurality of main switch modules corresponding to coils for each phase of a motor and allowing the main switch module to be switched by a control signal to provide the direct current power rectified by the AC-DC converting unit to the coil of each phase and to provide magnetic force generated by magnetic flux of the coil of each phase to a rotor;
a sub-driving unit including a plurality of sub-switch modules corresponding to the coils for each phase of the motor and allowing the sub-switch module to be switched by the control signal to provide the direct current power rectified by the AC-DC converting unit to the coil of each phase and to provide the magnetic force generated by the magnetic flux of the coil of each phase to the rotor;
a temperature sensor unit measuring and outputting a temperature of the main driving unit and the sub-driving unit; and
a controlling unit separately controlling the main driving unit or the sub-driving unit according to a state of the motor to rotate the motor and controlling the main driving unit or the sub-driving unit so that the main driving unit or the sub-driving unit which is being driven is turned off and the main driving unit or the sub-driving unit which is in a stop state is driven when the temperature measured by the temperature sensor unit becomes a predetermined temperature or more.

2. The parallel structure power apparatus as set forth in claim 1, wherein the controlling unit controls the main driving unit or the sub-driving unit to thereby turn off the main driving unit or the sub-driving unit which is being driven and drive the main driving unit or the sub-driving unit which is in the stop state when a malfunction is found in the main driving unit or the sub-driving unit which is being driven during the rotation of the motor.

3. The parallel structure power apparatus as set forth in claim 1, wherein the main driving unit is configured by a bridge circuit configured by the plurality of main switch modules for each phase connected to one another in parallel.

4. The parallel structure power apparatus as set forth in claim 1, wherein the plurality of main switch modules of the main driving unit are configured so that a pair of main semiconductor switches configured each by main transistors are connected to each other in series, the pair of main semiconductor switches having connection point which is an alternating current output portion, the connection point being connected to a three-phase exciting winding of the motor which is star-connected, and each of the main transistors being connected to each of main diodes in inverse-parallel.

5. The parallel structure power apparatus as set forth in claim 1, wherein the sub-driving unit is configured by a bridge circuit configured by the plurality sub-switch modules for each phase connected to one another in parallel.

6. The parallel structure power apparatus as set forth in claim 1, wherein the plurality of sub-switch modules of the sub-driving unit are configured so that a pair of sub-semiconductor switches configured each by sub-transistors are connected to each other in series, the pair of sub-semiconductor switches having a connection point which is an alternating current output portion, the connection point being connected to a three-phase exciting winding of the motor which is star-connected, and each of the sub-transistors being connected to each of sub-diodes in inverse-parallel.

7. The parallel structure power apparatus as set forth in claim 1, wherein the plurality of main switch modules of the main driving unit, which are each turned on by the control signal to provide magnetic force generated by magnetic flux of the corresponding phase to the rotor, are configured by a main upper switch and a main lower switch and turns on the main upper switch and the main lower switch according to the control signal to thereby provide the magnetic force generated by the magnetic flux of the corresponding phase to the rotor.

8. The parallel structure power apparatus as set forth in claim 1, wherein the main switch module of the main driving unit includes:
a main upper semiconductor switch including a main upper transistor element connected to one side of the coil of the corresponding phase to intermit supply power according to the control signal input through a control terminal and a protection diode protecting the main upper transistor element from counter electromotive force generated from the coil of the corresponding phase at the time of turning on and off the main upper transistor element; and
a main lower semiconductor switch including a main lower transistor element connected to the other side of the coil of the corresponding phase to intermit supply power according to the control signal input through the control terminal and a protection diode protecting the main lower transistor element from counter electromotive force generated from the coil of the corresponding phase at the time of turning on and off the main lower transistor element.

9. The parallel structure power apparatus as set forth in claim 1, wherein the sub-switch modules of the sub-driving unit, which are each turned on by the control signal to provide magnetic force generated by magnetic flux of the corresponding phase to the rotor, are configured by a sub-upper switch and a sub-lower switch and turns on the sub-upper switch and the sub-lower switch according to the control signal to thereby provide the magnetic force generated by the magnetic flux of the corresponding phase to the rotor.

10. The parallel structure power apparatus as set forth in claim 1, wherein the sub-switch module of the sub-driving unit includes:
a sub-upper semiconductor switch including a sub-upper transistor element connected to one side of the coil of the corresponding phase to intermit supply power according to the control signal input through a control terminal and an upper protection diode protecting the sub-upper transistor element from counter electromotive force generated from the coil of the corresponding phase at the time of turning on and off the sub-upper transistor element; and
a sub-lower semiconductor switch including a sub-lower transistor element connected to the other side of the coil of the corresponding phase to intermit supply power according to the control signal input through the control terminal and a protection diode protecting the sub-lower transistor element from counter electromotive force generated from the coil of the corresponding phase at the time of turning on and off the sub-lower transistor element.

11. A parallel structure power apparatus, comprising:
an alternating current-direct current (AC-DC) converting unit rectifying an alternating current power to thereby generate a direct current power;
a main driving unit including a plurality of main switch modules including a pair of main switches corresponding to coils for each phase of a motor and allowing the main switch module to be switched by a control signal to provide the direct current power rectified by the AC-DC converting unit to the coil of each phase and to provide magnetic force generated by magnetic flux of the coil of each phase to a rotor;
a sub-driving unit including a plurality of sub-switch modules including a pair of sub-switches corresponding to the coils for each phase of the motor and allowing the sub-switch module to be switched by the control signal to provide the direct current power rectified by the AC-DC converting unit to the coil of each phase and to provide the magnetic force generated by the magnetic flux of the coil of each phase to the rotor;
a temperature sensor unit measuring and outputting a temperature of each of the main switches of the plurality of main switch modules of the main driving unit and a temperature of each of the sub-switches of the plurality of sub-switch modules of the sub-driving unit; and
a controlling unit separately controlling the main driving unit or the sub-driving unit according to a state of the motor to rotate the motor and controlling the main driving unit or the sub-driving unit so that a corresponding main switch in the main switch module of the main driving unit or the sub-switch in the sub-switch module of the sub-driving unit which is being driven at a measured temperature of a predetermined temperature or more is turned off and the main switch in the main switch module of the main driving unit or the sub-switch in the sub-switch module of the sub-driving unit which is in a corresponding stop state is driven in the case in which the measured temperature of the predetermined temperature or more is found among the measured temperatures of the respective main switches of the plurality of main switch modules and the respective sub-switches of the sub-switch modules measured by the temperature sensor unit.

12. A parallel structure power apparatus, comprising:
an alternating current-direct current (AC-DC) converting unit rectifying an alternating current power to thereby generate a direct current power;
a main driving unit including a plurality of main switch modules corresponding to coils for each phase of a motor and allowing the main switch module to be switched by a control signal to provide the direct current power rectified by the AC-DC converting unit to the coil of each phase and to provide magnetic force generated by magnetic flux of the coil of each phase to a rotor;
a sub-driving unit including a plurality of sub-switch modules corresponding to the coils for each phase of the motor and allowing the sub-switch module to be switched by the control signal to provide the direct current power rectified by the AC-DC converting unit to the coil of each phase and to provide the magnetic force generated by the magnetic flux of the coil of each phase to the rotor; and
a controlling unit controlling the main driving unit or the sub-driving unit according to a state of the motor to rotate the motor and turning off the main driving unit or the sub-driving unit which is being driven and driving the main driving unit or the sub-driving unit which is in a stop state when a malfunction is found in the main driving unit or the sub-driving unit which is being driven.

13. The parallel structure power apparatus as set forth in claim 12, wherein the main driving unit is configured by a bridge circuit configured by the plurality of main switch modules for each phase connected to one another in parallel, and
the sub-driving unit is configured by a bridge circuit configured by the plurality sub-switch modules for each phase connected to one another in parallel.

14. The parallel structure power apparatus as set forth in claim 12, wherein the plurality of main switch modules of the main driving unit, which are each turned on by the control signal to provide magnetic force generated by magnetic flux of the corresponding phase to the rotor, are configured by a main upper switch and a main lower switch and turns on the main upper switch and the main lower switch according to the control signal to thereby provide the magnetic force generated by the magnetic flux of the corresponding phase to the rotor, and
the plurality of sub-switch modules of the sub-driving unit, which are each turned on by the control signal to provide magnetic force generated by magnetic flux of the corresponding phase to the rotor, are configured by a sub-upper switch and a sub-lower switch and turns on the sub-upper switch and the sub-lower switch according to the control signal to thereby provide the magnetic force generated by the magnetic flux of the corresponding phase to the rotor.

15. A control method of a parallel structure power apparatus, the control method comprising:
converting, by an alternating current-direct current (AC-DC) converting unit, an alternating current power into a direct current power and providing the converted direct current power;
generating, by a controlling unit, a control signal according to a state of a motor to control a main driving unit or a sub-driving unit;
measuring and outputting, by a temperature sensor unit, a temperature of the main driving unit or the sub-driving unit; and
changing and operating, by the controlling unit, the main driving unit or the sub-driving unit which is being driven to the main driving unit or the sub-driving unit which is in a stop state when the temperature of the main driving unit or the sub-driving unit measured by the temperature sensor unit is a predetermined temperature or more.

16. The control method as set forth in claim 15, wherein the changing and operating of the main driving unit or the sub-driving unit includes:
measuring and transmitting, by the temperature sensor unit, the temperature of the main driving unit or the sub-driving unit;
determining, by the controlling unit, whether or not the temperature measured by the temperature sensor unit is the predetermined temperature or more; and
changing and operating, by the controlling unit, the main driving unit or the sub-driving unit which is being driven to the main driving unit or the sub-driving unit which is in the stop state when the temperature is the predetermined temperature or more based on the determination.

17. The control method as set forth in claim 15, further comprising: changing and operating, by the controlling unit, the main driving unit or the sub-driving unit which is being driven to the main driving unit or the sub-driving unit which is in the stop state when a malfunction is found in the main driving unit or the sub-driving unit which is being driven.

18. The control method as set forth in claim 15, further comprising: turning off, by the controlling unit, a corresponding switch module of the main driving unit or a corresponding switch module of the sub-driving unit which is being driven, and changing and operating the corresponding switch module of the main driving unit or the corresponding switch module of the sub-driving unit to the corresponding main switch module of the main driving unit or the corresponding switch module of the sub-driving unit which is in the stop state when a malfunction is found in the respective switch modules of the main driving unit or the respective switch modules of the sub-driving unit which is being driven.

19. A control method of a parallel structure power apparatus, the control method comprising:
converting, by an alternating current-direct current (AC-DC) converting unit, an alternating current power into a direct current power and providing the converted direct current power;
generating, by a controlling unit, a control signal according to a state of a motor to control a main driving unit or a sub-driving unit;
measuring and outputting, by a temperature sensor unit, a temperature of each of main switches of a plurality of main switch modules of the main driving unit and a temperature of each of sub-switches of a plurality of sub-switch modules of the sub-driving unit; and
turning off, by the controlling unit, a corresponding main switch in the main switch module of the main driving unit or a sub-switch in the sub-switch module of the sub-driving unit which is being driven at a measured temperature of a predetermined temperature or more and driving the main switch in the main switch module of the main driving unit or the sub-switch in the sub-switch module of the sub-driving unit which is in a corresponding stop state in the case in which the measured temperature of the predetermined temperature or more is found among the measured temperatures of the respective main switches of the plurality of main switch modules and the respective sub-switches of the sub-switch modules measured by the temperature sensor unit.
